(19) United States
(12) Patent Application Publication
(10) Pub. No.: US 2017/0088262 A1
(43) Pub. Date: Mar. 30, 2017

(54) RELEASE PIN AND CABLE ACTUATOR FOR 3 RING RELEASE MECHANISM

(71) Applicant: The United States of America as Represented by the Secretary of Agriculture, Washington, DC (US)

(72) Inventor: Kevin Brown, Missoula, MT (US)

(73) Assignee: The United States of America as Represented by the Secretary of Agriculture, Washington, DC (US)

(21) Appl. No.: 15/225,679

(22) Filed: Aug. 1, 2016

Related U.S. Application Data
(60) Provisional application No. 62/232,305, filed on Sep. 24, 2015.

(51) Int. Cl. B64D 1/22; F16B 21/12; F16B 21/02; B64D 17/38

(52) U.S. Cl. CPC B64D 1/22; B64D 17/38; F16B 21/12; F16B 21/02

(57) ABSTRACT

An automated quick release mechanism for a three-ring release comprising a pneumatic or hydraulic cylinder with a hardened metal pin engaging a loop of the three ring release. When engaged with the three-ring release, the pin is held in an extended position to engage the loop of the release. Actuation to withdraw the pin disengages the pin from the string loop, allowing the three-ring release to open.

### FIELD OF THE INVENTION

The technology relates to quick release mechanisms, e.g., for rapid decoupling of a tether or strap. In particular, the technology relates to a solid release pin and cable assembly for use with 3-ring release systems as are used, e.g., for rapid release of parachutes, tethered cargo, etc.

### BACKGROUND OF THE INVENTION

3-ring release systems, e.g., as described in U.S. Pat. No. 4,337,913, which is incorporated herein by reference for all purposes, comprise series of rings attached to a pair of straps that are to be reversibly attached to each other. Typically, a largest ring is attached to one strap and other rings are attached to a second strap, with each ring being insertable through the next larger ring in the series, with the smallest ring being secured by a retainer loop that is itself secured by a removable cable or cord of a release mechanism. Rapid uncoupling of the two straps is accomplished by withdrawing the cord from the retainer loop, such that the rings can then sequentially uncouple, thereby allowing the straps to separate.

Release actuation typically consists of a T-handle or a ring that is gripped and pulled to remove the release cord from the retainer loop. Flexible nylon cable or nylon-coated steel cable is often used for the release cord, and such cables, when subjected to high-tension loading on the 3-ring system, will deflect, which causes an increase in the pull force needed to effect the release. Further, cable release systems typically have a large pull distance, i.e., the cable must move a substantial distance in order to release the retainer loop of the 3-ring system. The long pull distance limits the types and configurations of actuating devices that can be practically used with these systems.

### SUMMARY OF THE INVENTION

The technology provided herein is directed to an improved release mechanism for a 3-ring release system. Embodiments of the technology are shown, e.g., in FIGS. 1-6, and an exemplary 3-ring release usable with the technology is shown in FIG. 7.

In some embodiments, the release mechanism for a 3-ring release system comprises a solid pin release assembly (19) comprising support plate (1) having a proximal portion and a distal portion, the support plate (1) having a through-hole (2) that connects a top surface and a bottom surface of support plate (1) and that comprises a perimeter. The proximal portion of support plate (1) comprises a longitudinal bore (4) between a proximal end of support plate (1) and the through-hole (2). The solid pin release assembly (19) comprises a release pin (7) in longitudinal bore (4) of the support plate, configured such that the release pin (7) is moveable between an extended position in which a distal end of the release pin (7) crosses both the proximal and distal sites on the perimeter of through-hole (2), and a retracted position in which the distal end of said release pin (7) does not cross said distal site on the perimeter of through-hole (2). In certain preferred embodiments, when the release pin (7) is in said retracted position, said distal end of the release pin (7) does not cross any site on the perimeter of through-hole (2), such that the through-hole is completely clear of the release pin.

In some embodiments, the proximal end of release pin (7) is attached to a cable (8) in a cable assembly (18), e.g., as illustrated in FIG. 5.

In some embodiments, the distal end of the support plate is configured to support and/or stabilize the distal end of the release pin when the pin is extended across the through-hole, e.g., when it is engaged with a retainer loop of a 3-ring release. For example, in some embodiments, the distal portion of support plate (1) comprises a slot or bore, such that when the release pin (7) is in the extended position, the distal end of said release pin (7) is fitted in said slot or bore, e.g., as illustrated FIG. 3.

The release pin is not limited to any particular composition, and requires only that the release pin is rigid in use, i.e., that it is composed of material that does not bend or deflect under load, e.g., from a 3-ring release. In some embodiments, release pin (7) is composed of solid metal and in some embodiments, release pin (7) is, e.g., rolled or layered metal or is a rigid composite, e.g., a metal-reinforced ceramic. In preferred embodiments, release pin (7) is solid metal. In particularly preferred embodiments, the metal comprises steel, aluminum, and/or titanium.

It is contemplated that the cable assembly and the support plate are detachable, e.g., such that the support-plate may be moved from one cable assembly to another, to suit different configuration or installation requirements. Thus, in some embodiments, cable assembly (18) is reversibly attached to support plate (1). In certain preferred embodiments, cable assembly (18) comprises a conduit (9) and conduit cap (10), wherein cable assembly (18) is reversibly attached to support plate (1) by engagement between support plate (1) and conduit cap (10). In particularly preferred embodiments, engagement between support plate (1) and conduit cap (10) comprises use of a pin, screw, and/or a clip, e.g., a set screw positioned as illustrated in FIGS. 1 and 2.

In some embodiments, the release mechanism of the technology further comprises an actuator (12) attached to an end of cable assembly (18). For example, any one of the embodiments of the release mechanism described above may comprise a lever as an actuator (12). In preferred embodiments, the lever is configured for operation using one hand, e.g., in the manner of a bicycle hand brake. In other embodiments, the actuator may comprise a button, knob, thumb lever, etc. In some embodiments, the actuator comprises an electric motor. Regardless of the form of actuator used, in particularly preferred embodiments, the actuator (12) is configured for reversible attachment to an aircraft control device, e.g., so the release mechanism may be quickly installed for use in a variety of different aircraft.

The technology further provides devices comprising the release mechanism described herein. For example in some embodiments, the technology provides a safety device for an aircraft comprising a 3-ring release mechanism comprising a retainer loop (13) and a release mechanism having any of the configurations described above in which the release pin (7) is positioned to reversibly engage a retainer loop (13) of the 3-ring release. In preferred embodiments, the safety device is a portable safety device for an aircraft.

The technology includes and contemplates devices and related embodiments such as those embodiments portrayed in FIGS. 1-7.

### DEFINITIONS

To facilitate an understanding of the present technology, a number of terms and phrases are defined below. Additional definitions are set forth throughout the detailed description.

As used herein, “a” or “an” or “the” can mean one or more than one. For example, “a” widget can mean one widget or a plurality of widgets.

As used herein, the term “strap” refers to any material attachable to and joinable using a 3-ring release mechanism, including, e.g., webbing and other fabric strips of nylon, silk, cotton, polyester, etc., leather strips, mesh materials of natural or synthetic fibers, metal strands, and strips or strands composed of composite materials.

### DESCRIPTION OF THE DRAWINGS

Features, aspects, and advantages of the present technology will become better understood with regard to the following drawings:

FIG. 1 shows a top cross-sectional view of an embodiment of a solid pin release assembly showing support plate (1) having a longitudinal bore (4) configured to contain solid release pin (7). Support plate through-hole (2) is provided for a retainer loop of a 3-ring release system to pass through support plate (1) from the bottom of the support plate and engage with the solid release pin (7) when the release pin is in an extended position, e.g., when the release pin crosses the diameter of the through-hole (2).

FIG. 2 shows a side cross-sectional view of an embodiment of a solid pin release assembly.

FIG. 3 shows an embodiment of the solid pin release assembly with release pin (7) extended across through-hole (2) in support plate (1) and resting in a distal slot of the support plate. Conduit cap (10) is engaged to support plate (2) by a set screw in set screw hole (5).

FIG. 4 shows an embodiment of the solid pin release assembly with release pin (7) partially retracted into bore (4), exposing distal slot (3).

FIG. 5 shows a configuration of a release assembly comprising a cable assembly (18) 110 and a support plate (1). In the diagram shown, cable assembly (18) is disengaged from support plate (1) and release pin (7) is shown attached to cable (8) of cable assembly (18). Conduit cap (10) comprises a groove (11) to engage a set screw (6) when the cable assembly is attached to support plate (1). In this embodiment, solid pin release assembly (19) comprises release pin (7) and support plate (1).

FIG. 6 shows an embodiment in which a first end of a cable assembly (18) is attached to an actuator (12) (a lever) and a second end of the cable assembly (18) is attached to a support plate (1) on a webbing strap (16) positioned for engagement to a 3-ring release assembly (15). The largest ring of the 3-ring release assembly is attached to a separate portion of webbing strap (17).

FIG. 7 shows an exemplary 3-ring release system (15), usable with a solid pin release assembly provided by the present technology. Retainer loop (13) of such a 3-ring release passes through an access hole, e.g., a grommet (14) that in use is aligned with through-hole (2) of support plate (1) of a solid pin release system on the reverse side of strap (16), as diagrammed in FIG. 6.

### DETAILED DESCRIPTION OF THE INVENTION

Three-ring release mechanisms are employed in a number of systems requiring rapid release of one cable or strap from a second cable or strap, e.g., in jettisoning a malfunctioning parachute from a chutist, and in effecting emergency release of external cargo from an aircraft, e.g., from a helicopter. While not limited to any particular use or application, the technology herein finds particular use in aircraft external cargo systems, including but not limited to Class D human external cargo (HEC) safety tethers employing 3-ring release systems.

Current release cords for Class D HEC 3-ring systems typically consist of a nylon or nylon-coated steel cable. When the 3-ring system is subjected to high tension loading, such flexible cables will deflect, causing an increase in the pull force necessary to actuate the release. Further, these systems typically have a long throw (requiring, e.g., 8″ to 18″ of pull to release the 3-ring system), so actuation of the release generally requires use of a ‘T’ handle or ring that is gripped and pulled to withdraw the release cord, as use of a lever actuator would require a very large lever to accomplish the necessary throw. Because of these constraints, actuators for such systems cannot be practically mounted on aircraft flight controls, and a pilot must move a hand away from the aircraft controls in order to actuate such release mechanisms.

Technology herein provides a quick release pin assembly for use with a 3-ring release system. The release assembly comprises a solid release pin that does not bend or deflect, coupled with a support plate that further ensures against any deflection of the release pin, even under very heavy load. In preferred embodiments, the throw or travel distance of the release pin is no more than 8″, preferably no more than 5″, more preferably no more than 3″. In particularly preferred embodiments, e.g., as used on safety tether, the release pin of the solid pin release system has a travel distance of 2″ or less between a fully extended position, and a position in which the release pin is sufficiently retracted to release a retainer loop of a 3-ring release system.

The support plate of the release assembly comprises a bore into which the solid release pin withdraws when the release system is actuated, which further ensures that the movement of the release pin is shielded from outside interference during actuation. In some embodiments the release assembly further comprises a cable for controlling the position of the release pin, e.g., a cable in a conduit housing, and an actuator for moving the solid release pin within the support plate.

In some embodiments the solid pin release assembly and a cable are used with a lever actuator. The lever actuator adds mechanical advantage to moving the release pin, and further allows mounting the actuator on flight controls of an aircraft.

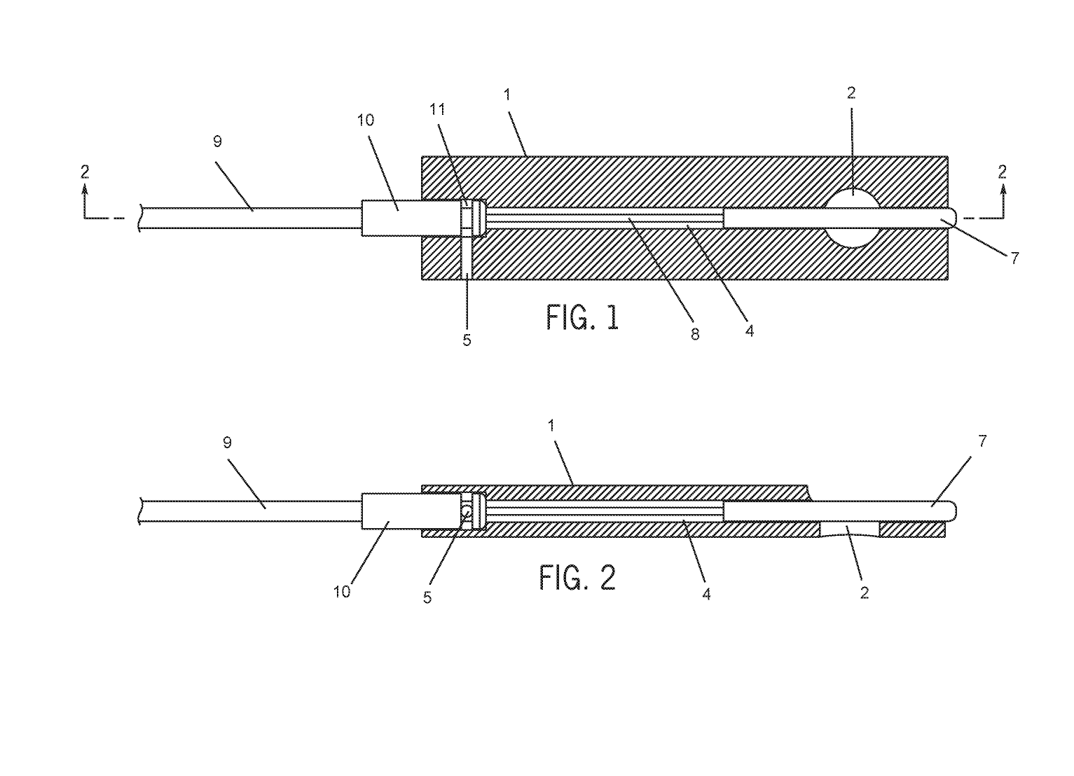

FIG. 1 shows a top cross-sectional view of a portion of an embodiment of the release cable assembly showing support plate (1) having a longitudinal bore (4) configured to contain solid release pin (7). A through-hole (2) in support plate (1) is provided to allow a retainer loop of a 3-ring release system to pass through the support plate (1) and engage with release pin (7) when the release pin is in the extended position.

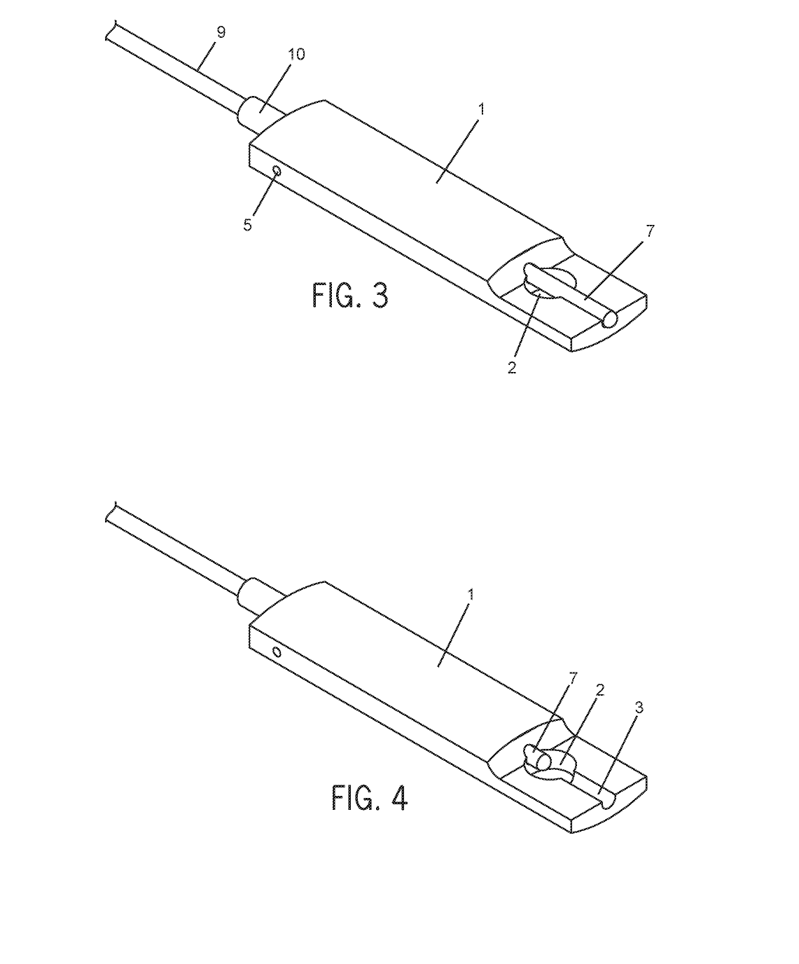

Support plate (1) is not limited to any particular shape. In preferred embodiments, the support plate is has a shape selected such that, when secured to a 3-ring release system, the support plate cannot significantly rotate around any axis, e.g., its longitudinal axis. In particularly preferred embodiments, the support plate has a length greater than its width, and is of sufficient thickness to accommodate a longitudinal bore (4) having a diameter effective to enclose release pin (7). In some embodiments, the support plate (1) is generally a flattened bar-shaped, e.g., as shown in FIGS. 1-6, and in preferred embodiments, support plate (1) has a generally rectangular shape in a top view, e.g., as shown schematically in FIG. 1. Surfaces of the support plate (e.g., top and bottom surfaces, edges along sides and ends) may be flat or may be, e.g., concave, convex, reflex, or have dimples or other features. In some embodiments, an external surface of a support plate comprises one or more features (e.g., dips, grooves, ridges, holes, textures) configured to aid in handling and/or securing the solid pin release assembly, e.g., during handling or while attached to a 3-ring release system.

As used herein in describing elements of a solid pin release assembly, “proximal” refers to part(s) of an element that are closer to the cable attachment end of the assembly, and “distal” refers to part(s) of an element that are closer to opposite end of the assembly. By way of example, in the embodiment shown in FIG. 1, the proximal portion of release pin (7) is attached to cable (8) and the distal portion of release pin (7) comprises a tip that moves across through-hole (2) in support plate (1) when release pin (7) is extended or retracted.

In a preferred embodiment, longitudinal bore (4) in the proximal portion of support plate (1) is configured to contain the entire length of release pin (7) when the release pin is in a fully retracted position, e.g., when it is retracted to release a retainer loop (13) of a 3-ring release system. In some embodiments release pin (7) is shorter than the length of bore (4), while in some embodiments release pin (7) is longer than bore (4), such that a portion of the release pin (7) remains exposed outside bore (4) when the release pin is in a fully-retracted position. In yet other embodiments, release pin (7) is the same length as bore (4). In preferred embodiments, the distal tip of release pin (7) does not overlap with the perimeter of through-hole (2) when release pin (7) is in a fully-retracted position, e.g., when release pin (4) cannot be further moved into bore (4) using the ordinary actuation mechanism (12), e.g., an attached lever.

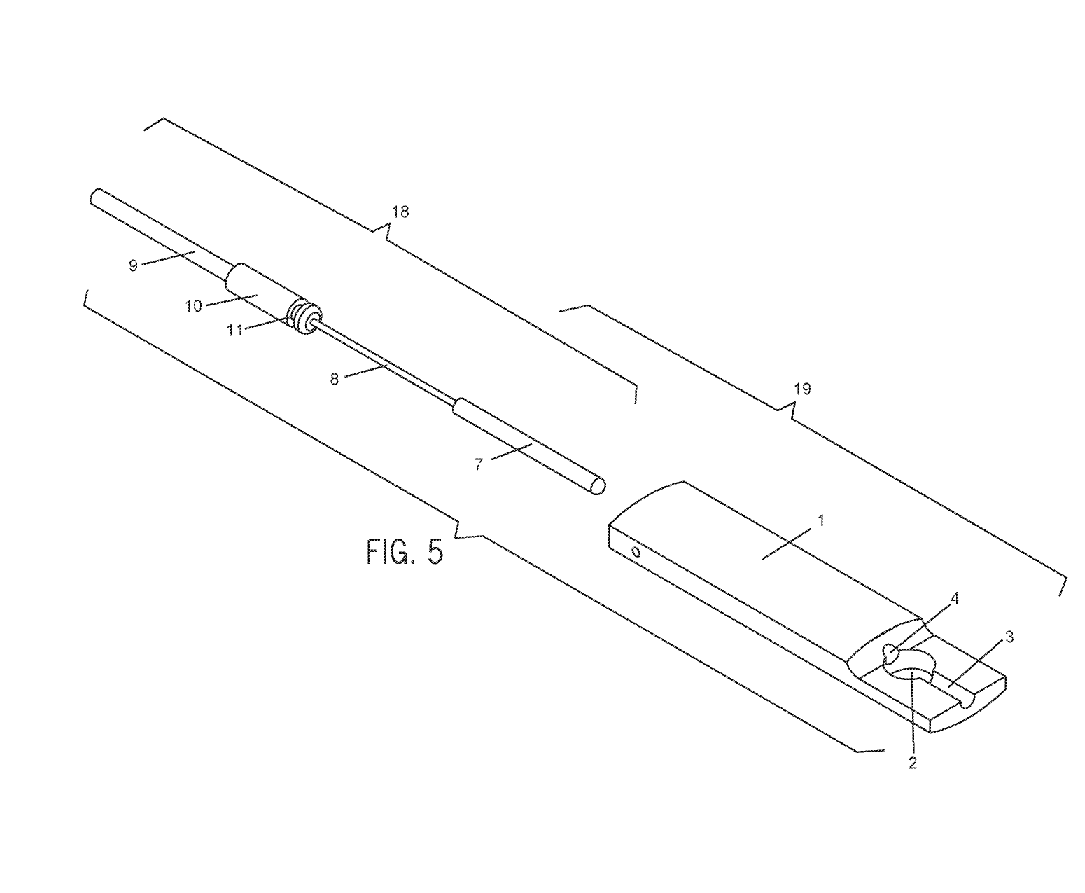

On the distal side of through-hole (2), i.e., on the side opposite bore (4), support plate (1) comprises a distal portion configured to receive and/or support the distal end of release pin (7) when the pin is in the extended position across through-hole (2). In some embodiments, the distal portion of support plate (1) comprises a groove or slot (e.g., a v-groove, u-groove, etc.) that the distal end of release pin (7) rests in or fits in when release pin (7) is in an extended position. For example, the embodiment shown in FIGS. 4-5 shows a distal receiving slot (3). In other embodiments, the distal portion of support plate (1) may comprise a second bore rather than a groove or slot, such that the second bore is axially aligned with bore (4) and is positioned to receive the distal end of release pin (7) when the release pin is extended. In preferred embodiments, a distal bore extends through distal portion of support plate (4) to the end, such that the distal end of release pin (7) is visible and/or protrudes from the end of support plate (1) when release pin (7) is in the fully-extended position. In some embodiments, the distal end of release pin (7) is colored or otherwise marked, e.g., to allow easy visual confirmation of its extended position.

In some embodiments, the distal end of release pin (7) is configured to receive a clip or pin (e.g., cotter pin, c-clip) to secure release pin (7) against withdrawal or accidental retraction from the fully-extended position, e.g., during moving or installation of a device comprising the 3-ring release assembly, e.g., a portable safety device (PSD). In preferred embodiments, such clips or pins comprise a warning marker (e.g., flag, ribbon, etc.) indicating that the clip or pin must be removed to configure the device for use. The proximal end of release pin (7) is connected to a cable (8) (e.g., a steel strand metal rope; see, e.g., Cablecraft Motion Controls, New Haven, Ind.) by standard methods, e.g., by swage, nicopress, etc.

As shown in the embodiment depicted in FIGS. 1 and 2, the portion of cable (8) that is external to support plate (1) is contained within a housing or conduit (9). In preferred embodiments, conduit (9) comprises as an end fitting a conduit cap (10) through which cable (8) passes. Together, the cable (8), conduit (9), conduit cap (10), and attached release pin (7) form a cable assembly (18), as shown in FIG. 5. A first terminus of cable (8) is attached to release pin (7), as described above, and a second terminus of cable (8) is engaged with an actuator (12), e.g., a lever.

In particularly preferred embodiments, conduit cap (10) is configured to removeably engage support plate (1). For example, as diagramed in FIGS. 1 and 2, conduit cap (10) comprises a groove or recess (11) configured to receive a retaining pin or screw. In the embodiment shown, support plate (1) comprises at least one screw hole (5) configured to receive a set screw (6) that, when screwed in place, secures conduit cap (10) of the cable assembly (18) to support plate (1). The technology is not limited to any particular means of securing a cable assembly to support plate (1). For example, it is contemplated that a conduit cap may engage a support plate by any means of releasable connection, e.g., by a threaded connection, a bayonet connection, etc. It is further contemplated that a releasable connection may be further secured by means not only of one or more set screws, but alternatively, for example, by one or more of pins, slide locks, c-clips, etc. In preferred embodiments, the releasable connection between support plate (1) and conduit cap (10) is configured to allow a degree of rotation of the support plate around its longitudinal axis when the support plate is engaged with the conduit cap. For example, in the embodiment shown in FIGS. 1-2, The groove (11) encircles conduit cap (10) such that a set screw (6) can engage the groove in any rotational orientation.

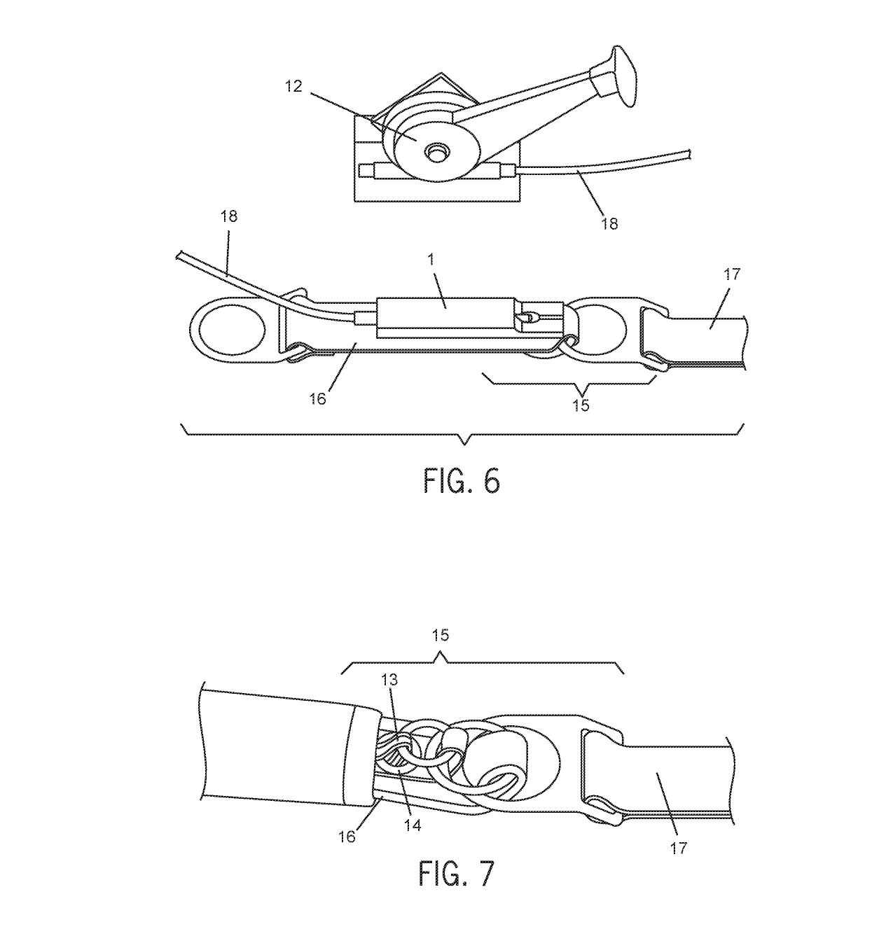

As diagrammed in FIG. 6., in preferred embodiments, the cable assembly and support plate/release pin assembly are used together with an actuator (12), which is configured to move release pin (7) into bore (4), thereby releasing a retainer loop of a 3-ring release system. In some embodiments, an actuator (12) is configured to push and pull cable (8) in both directions within conduit (9), while in other embodiments, actuator (12) is configured to only to pull cable (8) to retract release pin (7) into bore (4). In latter embodiments, the release pin (7) may be re-set in the extended position manually, e.g., by pulling the distal end of release pin (7) into the extended position across the though-hole (2) in support plate (1).

The technology is not limited to any particular type of actuating device, and comprises any means of pulling cable (8) through conduit (9). In some embodiments the actuator comprises or consists of a grippable member, e.g., a T-grip or a ring, while in other embodiments, the actuator may comprise a winch mechanism. In preferred embodiments, actuator (12) comprises a lever, e.g., as shown schematically in FIG. 6. In particularly preferred embodiments, the actuator comprises a lever operable using a single hand. In some particularly preferred embodiments, the actuator comprises a small hand lever that is mountable on, for example, a hand control of an aircraft, e.g., a cyclic stick of a helicopter. In some embodiments, operation of the actuator comprises operation of an electric switch.

The technology is not limited to particular 3-ring release systems. In some embodiments, a solid pin release assembly of the technology is used with an installed cargo hoisting system, e.g., with a system that is essentially permanently installed in an aircraft (e.g., bolted in place) such that it is typically removed during replacement, or for inspection, repair, or other servicing purposes. In other embodiments, the solid pin release system is used as part of a removable cargo-securing system, e.g., one that can be moved from aircraft to aircraft without modifying the aircraft, and without requiring re-inspection or recertification of the aircraft. In some preferred embodiments, the solid pin release system is implemented on a portable safety device (PSD), as set forth in U.S. Federal Aviation Administration requirements for portable safety devices for use in rotorcraft external-load operations.

### Embodiments of the Technology

In an exemplary embodiment of the technology, a release pin (7) is constructed of 0.19″ diameter 303 stainless steel and is swaged to aircraft-quality 7×7, 0.062 in. diameter wire rope or cable (8). The wire cable (8) passes through a 0.238 in. diameter conduit (9). The conduit is capped at one end by a brass fitting as conduit cap (10) and at the other end by a lever (12). The conduit cap (10) and release pin (7) are terminated in an attached support plate (1). The support plate (1) is milled from 6061 T6 aluminum, and is loosely attached to a support plate (1) with a set screw (6). In use with a 3-ring release, the through-hole (2) is centered on or around an access hole or grommet (14) of the 3-ring release, such that the retainer loop (13) of the 3-ring release system can pass through the grommet (14), and through through-hole (2) in support plate (1) to engage with the release pin (7) when the release pin is in an extended position across the through-hole. In use, the solid pin release assembly is secured in place on a strap or webbing with a wrap or cover, e.g., a fabric or leather cover that secures the support plate in position on the 3-ring release system.

The technology is not limited to the materials and dimensions recited above. For example, release pin (7) may be of any hardened material that is not flexible under the range of forces that would be encountered during use. Exemplary materials include hard and hardened metals, e.g., stainless steel, titanium, and alloys thereof. Similarly, the support plate may be steel, aluminum, copper, titanium, brass, etc. The elements of the solid release pin assembly (e.g., release pin (7), support plate (1)), the cable assembly (18) and the actuator (12) may be scaled to fit different sizes of 3-ring release systems and the variable needs of different installations, such as different configurations required by different aircraft. In some embodiments, the solid pin system is configured to be released electrically, e.g., such that an electric motor is configured to retract the release pin (7) into the bore (4) in support plate (1).

Although the disclosure herein refers to certain illustrated embodiments, it is to be understood that these embodiments are presented by way of example and not by way of limitation. All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in aviation mechanics, engineering, material science, release mechanism technology, or related fields are intended to be within the scope of the following claims.

What is claimed is:

1. A release mechanism for a 3-ring release system, the release mechanism comprising a solid pin release assembly (19) comprising support plate (1) having a proximal portion and a distal portion, said support plate (1) having a through-hole (2) connecting a top surface and a bottom surface of support plate (1) and comprising a perimeter, wherein said proximal portion of support plate (1) comprises a longitudinal bore (4) between a proximal end of support plate (1) and said through-hole (2), and
wherein said solid pin release assembly (19) comprises a release pin (7) in longitudinal bore (4), wherein said release pin (7) is moveable between an extended position wherein a distal end of said release pin (7) crosses proximal and distal sites on the perimeter of through-hole (2), and a retracted position, wherein said distal end of said release pin (7) does not cross said distal site on the perimeter of through-hole (2); and
wherein a proximal end of release pin (7) is attached to a cable (8) in a cable assembly (18).

2. The release mechanism of claim 1, wherein when said release pin (7) is in said retracted position, said distal end of the release pin (7) does not cross a site on the perimeter of through-hole (2).

3. The release mechanism of claim 1, wherein said distal portion of support plate (1) comprises a slot or bore, wherein when said release pin (7) is in said extended position, said distal end of said release pin (7) is fitted in said slot or bore.

4. The release mechanism of claim 1, wherein release pin (7) is composed of solid metal.

5. The release mechanism of claim 4, wherein said solid metal is selected from the group consisting of steel, aluminum, and titanium.

6. The release mechanism of claim 1, wherein cable assembly (18) is reversibly attached to said support plate (1).

7. The release mechanism of claim 6, wherein cable assembly (18) comprises a conduit (9) and conduit cap (10), wherein cable assembly (18) is reversibly attached to support plate (1) by engagement between support plate (1) and conduit cap (10).

8. The release mechanism of claim 7, wherein said engagement between support plate (1) and conduit cap (10) comprises use of a pin, screw, and/or a clip.

9. The release mechanism of claim 6, further comprising an actuator (12) attached to an end of cable assembly (18).

10. The release mechanism of claim 9, wherein said actuator (12) comprises a lever.

11. The release mechanism of claim 10, wherein said lever is configured for operation using one hand.

12. The release mechanism of claim 9, wherein said actuator (12) is configured for reversible attachment to an aircraft control device.

13. The release mechanism of claim 9, wherein said actuator (12) comprises an electric motor.

14. A portable safety device for an aircraft, said portable safety device comprising a 3-ring release mechanism comprising a retainer loop (13) and a release mechanism of any one of claims 1-13, wherein said release pin (7) is positioned to reversibly engage retainer loop (13).
